(19) United States
(12) Patent Application Publication
(10) Pub. No.: US 2022/0122464 A1
(43) Pub. Date: Apr. 21, 2022

(54) SYSTEM AND METHOD FOR TRACKING VESSELS

(71) Applicant: MAEROSPACE CORPORATION, Waterloo (CA)

(72) Inventors: Brian FRANKLIN, Waterloo (CA); Ryan Alexander ANDERSON, Waterloo (CA); Eric MEGER, Waterloo (CA)

(21) Appl. No.: 17/421,979

(22) PCT Filed: Jan. 10, 2020
(86) PCT No.: PCT/CA2020/050027

§ 371 Date: Jul. 9, 2021

Related U.S. Application Data
(60) Provisional application No. 62/791,293, filed on Jan. 11, 2019.

(51) Int. Cl. G08G 3/00

(52) U.S. Cl. CPC G08G 3/00

(57) ABSTRACT

A vessel tracking system and method are provided. The system comprises a processor, and a memory comprising a sequence of instructions which when executed by the processor configure the processor to perform the method. The method comprises obtaining characteristics data of a vessel, obtaining destination identifiers for historical destinations of vessels having similar characteristics data, determining a percentage of likelihood for each destination identifier, and reporting the destination identifiers and corresponding percentages of likelihood.

### CROSS REFERENCE TO RELATED APPLICATIONS

This application is a non-provisional of, and claims all benefit, including priority to, U.S. Application No. 62/791,293, dated Jan. 11, 2019 and entitled System and Method for Tracking Vessels, herein incorporated in its entirety by reference.

### FIELD

The present disclosure generally relates to the field of marine vessels, and in particular to a system and method for tracking vessels.

### INTRODUCTION

Currently, there is no reliable way to know where a ship is headed, except for published routes (in the case of ferries or cruise ships, or destinations of cargo ships). A significant number of vessels of interest (e.g., bulk cargo carriers: oil, coal, ore, and the like) only share these details with their ship owners and perhaps the cargo owners, but do not generally make these details available to anyone else. The Automatic Identification System (AIS; mandated by the IMO for all ships over 300 gross tonnes or carrying passengers) provides a mechanism to report current destination amongst other things, but it is seldom correct or interpretable, and therefore of little value for tracking vessels.

### SUMMARY

In accordance with an aspect, there is provided a vessel tracking system comprising a processor, and a memory comprising a sequence of instructions which when executed by the processor configure the processor to obtain characteristics data of the vessel, obtain destination identifiers for historical destinations of vessels having similar characteristics data, determine a percentage of likelihood for each destination identifier, and report the destination identifiers and corresponding percentages of likelihood.

In accordance with another aspect, there is provided a method of tracking a vessel. The method comprises obtaining characteristics data of the vessel, obtaining destination identifiers for historical destinations of vessels having similar characteristics data, determining a percentage of likelihood for each destination identifier, and reporting the destination identifiers and corresponding percentages of likelihood.

In accordance with another aspect, there is provided a vessel tracking system. The vessel tracking system comprises a processor, and a memory comprising a sequence of instructions which when executed by the processor configure the processor to obtain characteristics data and a destination identifier of a vessel, determine a path taken by each vessel having similar characteristics data and similar current position and destination identifier starting from a current location of the vessel as provided in a current position report, and determine a most probable path and corresponding estimated time of arrival for the vessel.

In accordance with another aspect, there is provided a method of tracking a vessel. The method comprises obtaining characteristics data and a destination identifier of a vessel, determining a path taken by each vessel having similar characteristics data and similar current position starting from a current location of the vessel as provided in a current position report, and destination identifier, and determining a most probable path and corresponding estimated time of arrival for the vessel.

In accordance with another aspect, there is provided a vessel tracking system. The vessel tracking system comprises a processor, and a memory comprising a sequence of instructions which when executed by the processor configure the processor to collect vessel data, group collected vessel data into subsets based on vessel identifiers for the vessel data, identify and group doppelganger vessels, identify voyages for each vessel, tag voyage position reports with destination identifiers, and store tagged reports in a repository.

In accordance with another aspect, there is provided a method of tracking a vessel. The method comprises collecting vessel data, grouping collected vessel data into subsets based on vessel identifiers for the vessel data, identifying and grouping doppelganger vessels, identifying voyages for each vessel, tagging voyage position reports with destination identifiers; and storing tagged reports in a repository.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### BRIEF DESCRIPTION OF THE FIGURES

Embodiments will be described, by way of example only, with reference to the attached figures, wherein in the figures:

FIG. 1 illustrates, in a component diagram, an example of a vessel tracking system, in accordance with some embodiments;

FIG. 2 illustrates, in a flowchart, an example of a method of tracking a vessel, in accordance with some embodiments;

FIG. 3 illustrates, in a screenshot, an example of a navigation display showing possible destinations of a vessel, in accordance with some embodiments;

FIG. 4 illustrates, in a screenshot, an example of a method of tracking a vessel, in accordance with some embodiments;

FIGS. 5A and 5B illustrate, in screenshots, examples of navigation displays showing paths to destination of a vessel, in accordance with some embodiments;

FIG. 6 illustrates, in a flowchart, an example of a method of collecting vessel information, in accordance with some embodiments;

FIGS. 7A to 7C illustrate, in component diagrams, other examples of a vessel tracking system, in accordance with some embodiments;

FIG. 8 shows a schematic block diagram of a system architecture in accordance with an illustrative embodiment;

FIG. 9 shows a schematic diagram of marine vessel positions shown on a map based on satellite automatic identification system (S-AIS) data for a vessel, in accordance with some embodiments;

FIG. 10 shows a schematic diagram illustrating forecasting a current location of a vessel based on previously received S-AIS data for a vessel, in accordance with some embodiments;

FIGS. 11A to 11C show illustrative examples of a probability cloud indicating one or more areas identified as being likely to include the vessel at three different points in time, in accordance with some embodiments;

FIG. 12 shows a schematic block diagram of a generic computing device which may provide an operating embodiment in one or more embodiments; and

FIG. 13 shows a flowchart of an example of a computer-implemented method for disambiguating Automatic Identification System (AIS) transmissions from different vessels using the same Maritime Mobile Service Identity (MMSI) identifier.

It is understood that throughout the description and figures, like features are identified by like reference numerals.

### DETAILED DESCRIPTION

Embodiments of methods, systems, and apparatus are described through reference to the drawings.

In some embodiments, commercially available satellite automatic identification system (AIS) data may be used to determine a location of a vessel. For example, many ships (e.g., tens of thousands) that carry AIS transponders may report moving state information as part of the AIS system. Such data is reported from the areas of ship travel. AIS is an internationally mandated aid to navigation that broadcasts, among other things, the host vessel identification and location. AIS is required on all vessels over 300 gross tonnage and upwards engaged on international voyages, cargo ships of 500 gross tonnage and upwards not engaged on international voyages and passenger ships irrespective of size. Many countries, including the USA require that all fishing vessels within their jurisdiction also broadcast AIS.

AIS data providers include a constellation of satellites that collect AIS data, and/or terrestrial AIS networks. The AIS system allows the user to enter destination data in a few of the available message types. These messages are reported far less frequently than position reports. The destination information is manually entered, and often forgotten as crew tend to more important matters for example while leaving port. It is common to see out of date information in the destination fields (destination, estimated time of arrival (ETA)). Being manually entered, it is common to see spelling errors, or short form labels that do not align meaningfully with official naming conventions. In addition, some crew are instructed to purposefully obfuscate their destination so that competitors are not aware of their maneuvers (which could provide a commercial advantage).

In some embodiments, there is provided a software tool that takes as input characteristics of a vessel's state (e.g., location and heading, vessel type, speed, draught), and characteristics of weather conditions (e.g., surface winds, currents, sea state) and reports a list of zero or more probable destinations, where such probabilities are determined by examining previous behaviours of vessels in the same general area with the same general characteristics. In the case where destination is not trustworthy, having a list of probable destinations and associated probabilities allows an observer to inform a risk management practice. For example, to decide if deployment of resources (e.g., interdiction) based on a probable measure of incursion to an area of interest (AOI). The software tool can interpret the resulting probabilities and according to a defined threshold, create an alert to inform a user of possible behaviour that is of interest to them. Additionally, in the absence of updated position reports from a vessel of interest, the software tool can provide the past behaviour that was used to generate the probabilities as a probable prediction of behaviour thereby providing a probable current position.

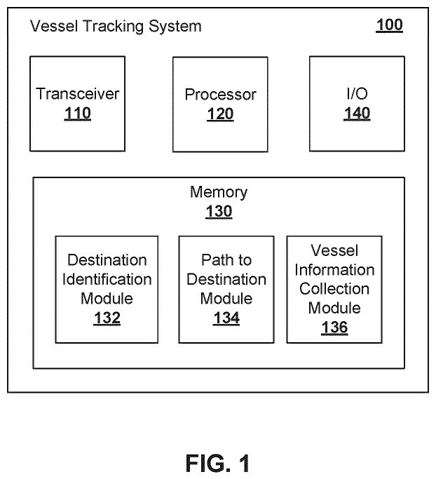

FIG. 1 illustrates, in a component diagram, an example of a vessel tracking system 100, in accordance with some embodiments. The system 100 comprises communication means such as a transceiver 110, a processor 120, a memory 130 and an input/output (I/O) unit 140. The transceiver 110 may communicate with AIS transponders on vessels to obtain location information of the vessels. In some embodiments, the transceiver 110 may receive AIS messages from the vessels. Additional information may be available from external/outside sources (e.g., weather services), including weather information (e.g., winds, current, sea state) and vessel characteristics not otherwise available from the AIS system. Examples of external/outside sources include maritime intelligence database services, and/or any other type of maritime intelligence information that is received by the transceiver 110, or inputted into the system manually via the I/O unit 140. The processor 120 may execute instructions stored in the memory 130. The memory 130 may include a destination identification module 132 for determining a destination for a vessel, a path to destination module 134 for determining destination paths for a vessel, and a vessel information collection module 136 for collecting vessel characteristics that may be stored in a database or data store in the same or a different memory, or that are transmitted to the system 100 from outside/external sources. The functions of the modules 132, 134, 136 will be described in more detail below. The memory 130 may store the location information, instructions executed by the processor 120, and other data. The I/O unit 140 may allow operators of the system 100 to interact with the system 100. Other components may be added to the system 100, such as, for example, an alert or warning message module.

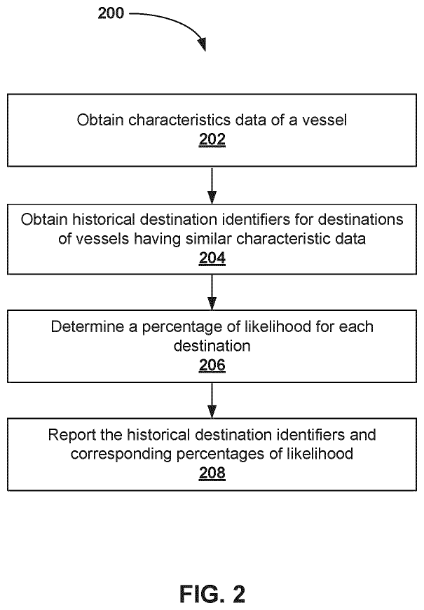

FIG. 2 illustrates, in a flowchart, an example of a method 200 of tracking a vessel, in accordance with some embodiments. The method 200 may be performed by the destination identification module 132 of the vessel tracking system 100. The method 200 comprises obtaining 202 characteristics data of the vessel. Such characteristics data may include a maritime mobile service identifier (MMSI) of the vessel, a current location of the vessel, a current heading of the vessel, a current speed of the vessel, a vessel type and a draught of the vessel. The characteristics data of the vessel are based on a current position report from the vessel. The vessel tracking method 200 may be performed at various locations of the vessel when the vessel transmits an AIS message. From additional sources (e.g., weather services), the vessel tracking method 200 may include weather characteristic data (e.g., surface winds, currents, sea state).

AIS data collection may be continuous (i.e., discrete values received periodically over a long period of time) using the AIS data standard. For example, a vessel may send position reports every six seconds while in motion, or every six minutes while docked at port. While in the open ocean, reports may be limited to being received periodically as per satellite coverage availability (e.g., could be several hours until in satellite range). At each report timestamp, the vessel's location and other characteristics may be plotted on a navigation map. The characteristic data for vessels may be stored in a common database 130, where there may be more than one location reported for each vessel at a different point in time.

Next, historical destination identifiers may be obtained 204 for destinations of vessels having similar characteristics data. The term “similar characteristics” may refer to data from the same specific vessel, similar vessel type (e.g., cargo, tanker, etc.), similar location, speed, sea state, and course (e.g., heading). The historical destination identifier may be obtained from historical position reports collected over a time period and tagged with the destination port at which the vessels having similar characteristics were ultimately found to have arrived. In some embodiments, the historic vessel reports may be stored in a database or other search repository. In other embodiments, the historic vessels reports may be parsed and the individual data would be stored in a database or other searchable repository.

Next, a percentage likelihood for each possible destination for the vessel is determined 206. The percentage likelihood of a particular destination may comprise a ratio between a number of vessels having similar characteristics that had the historical destination identifier associated with the particular destination identifier, and a total of all vessels having similar characteristics (e.g., a percentage of vessels with similar characteristics that have gone to a specific destination port from the vessel's current location in the past year.) For example, consider a vessel A having a current position report B. A percentage likelihood that vessel A is heading to a destination C can be determined by examining how many position reports for vessels having similar vessel characteristics have been received from the same or similar location of vessel A's current position B have ended up at destination C. I.e., if 50 of 200 position reports that match vessel A's current position and vessel characteristics ultimately ended up at destination C in the past year, then the percentage likelihood that vessel A is heading to destination C is 25 percent. It is understood that a different time frame (i.e., more or less than 1 year) lookback dataset may be used, and that such data may be collected annually, or multiple times within a year, to capture long term changes in travel behaviours. It is understood that a database of destination ports (e.g., the World Port Index published by the National Geospatial-Intelligence Agency) may be used as a reference to possible ports that vessels may enter. It is understood that settings may be set for what is considered to be a similar location of a vessel (i.e., within a certain amount of nautical distance of a current position report). It is understood that settings may be set for what characteristics data to use to determine similar vessel characteristics (i.e., for cargo vessels, vessel size and vessel draft characteristics may be used; for passenger transport vessels, vessel type and vessel size may be used; etc.).

Next, the historical destination identifiers and corresponding percentages of likelihood are reported 208 to a user interface of the software tool. In some embodiments, the reporting to the user interface may comprise a situational awareness mapping (i.e., overlaying the historical destination identifiers on a navigational map). Such outputs may be further processed by additional software to automatically generate alerts when vessels exhibit specified probable behaviours. Other steps may be added to the method 200, such as doppelganger detection as described further below, overlaying a predicted track on a navigation display, and sending an alert or warning message if the vessel is not where it is supposed to be based on a previous position.

In some embodiments, an alert or warning message may be sent if the vessel is not where it is supposed to be based on a previous position. Upon receiving a new position report from a vessel, the new position can be compared with the current probable position from a previous calculation of probable destination. If the newly reported position differs significantly (by some specified threshold) from the current probable position, then an alert could be issued to a user to signify a potential change in vessel behaviour from a previous assumption. The difference in position could be calculated as simply as an error vector between the probable position and newly reported position, and compared with a tolerance for deviation. In some embodiments, the vessel's likely destinations may be recalculated based on a new current position report for the vessel.

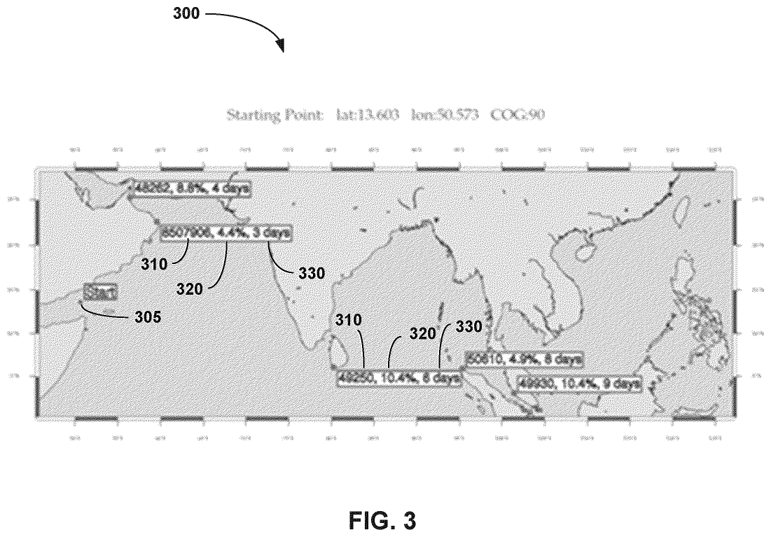

FIG. 3 illustrates, in a screenshot, an example of a navigation display 300 showing possible destinations of a vessel, in accordance with some embodiments. In this example, the starting point (i.e., current location of a vessel 305) is in the Gulf of Aden, and the destination identification module 112 of the vessel tracking system 100 returned a list (e.g., plotted on a navigation map) of port identifiers 310 and corresponding estimated time of arrival (ETA) 330, with a probability 320 (percentage of likelihood). For example, one port identifier 310, 49250 corresponds with Galle Harbor (in Sri Lanka), has an ETA 330 of 6 days from the vessel's current position (Start) and there is a 10.4% likelihood 320 that this is the destination port for the vessel. The plot only shows the top five ports for simplicity of presentation. It is understood that any number of, or all, ports may be displayed.

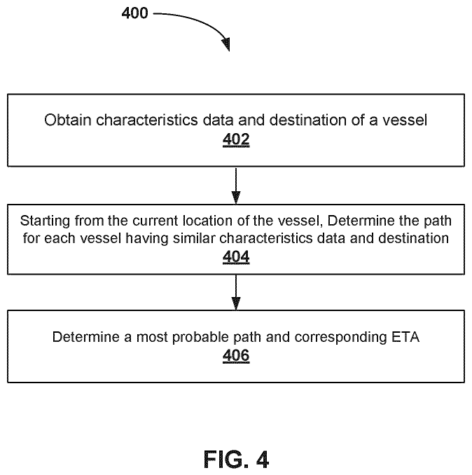

FIG. 4 illustrates, in a flowchart, an example of another method 400 of tracking vessels, in accordance with some embodiments. The method 400 may be performed by the path to destination module 134 of the vessel tracking system 100. The method 400 comprises obtaining 402 characteristics data and destination of the vessel. In some embodiments, the destination of the vessel may comprise a destination identifier and may be received as an input from the I/O 140 or may be determined as a highest probable destination for the vessel based on its current position report. Such characteristics data may include, for example, a maritime mobile service identifier (MMSI) of the vessel, and a current location of the vessel. Optionally, the characteristics data may also include at least one of a current heading of the vessel, a current speed of the vessel, and a destination port identifier (e.g., destination identifier). Next, starting from the current location of the vessel, the path for each vessel having similar characteristics data and destination is determined 404 as will be further described below. Next, routes between the current location and destination for vessels having similar characteristics may be bundled together to determine 406 a most probable path, and corresponding estimated time of arrival (ETA). For example, historical data regarding paths taken from vessels (having similar characteristics, similar current or starting position, and similar destination) may be used to determine a percentage probability for a path in the bundle of paths (i.e., a ratio of similar paths taken versus all paths taken for vessels with similar characteristics, current positions and destinations. It is understood that settings may be set for what is considered to be a similar location of a vessel (i.e., within a certain amount of nautical distance of a current position report). It is understood that settings may be set for what characteristics data to use to determine similar vessel characteristics (e.g., vessel type, heading, etc.), similar vessel positions (e.g., within a radius of the vessel's current position) and similar vessel destinations (e.g., within a radius of the vessel's destination or likely destination). Other steps may be added to the method 400, such as doppelganger detection as described above, overlaying a predicted track on a navigation display, comparing position updates from the vessel at intervals between the current location and the ETA, comparing current location to previously estimated paths, etc., and sending an alert or warning message if the vessel is not where it is supposed to be based on a previous position. In some embodiments, the vessel's path may be recalibrated based on a new current position report for the vessel.

For determining a path 404 for each vessel having similar characteristics, AIS data stored in a database may be “walked” through for vessels having the same characteristics that started at the current location and ended at the destination. For example, positions between the current location and the destination in position reports for each vessel having the same or similar characteristics may be plotted on a map and linked with lines showing possible paths. In some embodiments, ETA can be impacted by weather such as wind, sea state and surface currents, as described below. Alternatively, paths for each vessel may be stored and selected based on current location and destination. I.e., for a given current location, destination and vessel characteristics, paths may be predetermined and stored.

To bundle paths together 406, an A-star pathfinding algorithm, based on Dijkstra's Algorithm, may be used, having a custom “weight matrix” to guide the results along the paths vessels of the same characteristics have been observed before when heading to the same destination port. The weight matrix may be constructed to represent a portion of the earth that encompasses both the vessel location and the port location, and the extents of all similar vessel paths having been recorded going to the same destination in the prior year. The vessel paths are discretized along their length to align with the weight matrix cells, so that each point along a path contributes to the final weight matrix values, so that cells with greater weight are more “attractive”. This results in the best possible path from current location to destination, while adhering to previous observed behaviours, without following them rigorously. In some embodiments, multiple whole voyages (routes) may be extracted from a data store where the whole voyages (routes) share a common destination and common characteristics for the vessel of interest. The routes may all exhibit specific differences, but otherwise share a common general behaviour (including that they all end up at the same port). “Bundling” allows for multiple routes to be resolved to a single route which generally best describes the behaviour of the group of vessels having similar characteristics. The effect of the weight matrix as described above is to bundle multiple routes into a single representative route.

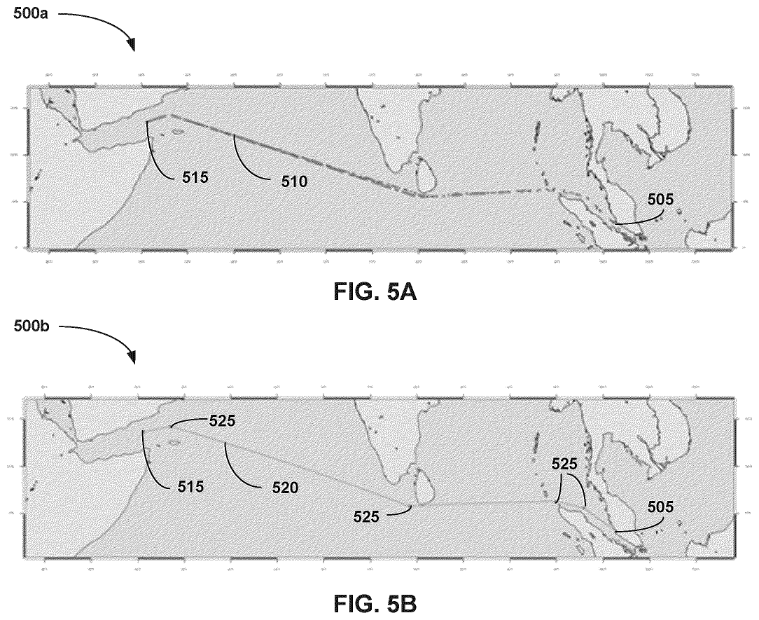

FIGS. 5A and 5B illustrate, in screenshots, examples of navigation displays 500a, 500b showing paths to destination of a vessel, in accordance with some embodiments. In this example, the starting point 505 (i.e., current location of a vessel) is near Singapore and the destination 515 is chosen as the Gulf of Aden. FIG. 5A shows multiple paths 510 from start to destination for the vessel as constructed by the path to destination module 134 of the vessel tracking system 100. FIG. 5B shows a single path 520 with waypoints 525 to the destination 515, as bundled by the path to destination module 134 of the vessel tracking system 100.

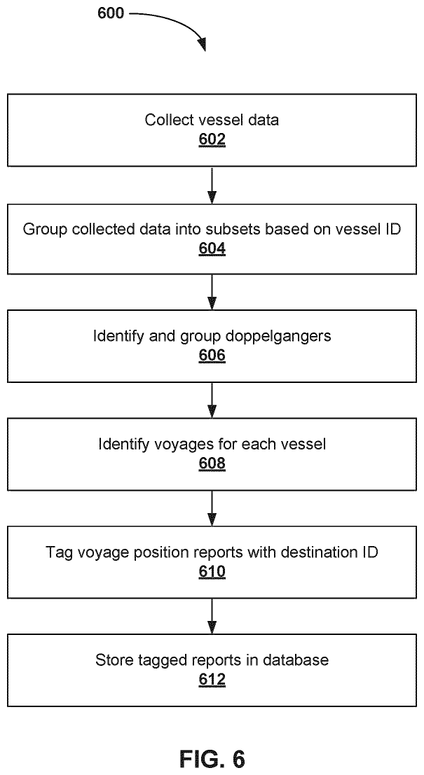

FIG. 6 illustrates, in a flowchart, an example of a method of collecting vessel information, in accordance with some embodiments. The method 600 may be performed by the vessel information collection module 136 of the vessel tracking system 100. The method 600 comprises collecting 602 vessel data. For example, a 1-year set of AIS position report data may be collected 602. AIS data for other time period data sets greater than or less than 1 year may be used. Next, the collected position report data may be grouped 604 into subsets based on vessel identifier (e.g., MMSI). For each vessel, “doppelgangers” may be identified 606 and further grouped into new subsets. Next, for each vessel subset, the data may be identified and divided 608 into zero or more voyages, where a voyage comprises a series of position reports that ultimately end in a port region. Each voyage position report is tagged 610 with the destination port identifier. The tagged position reports may then be stored 612 in a database that is structured and optimized for fast lookups. Other steps may be added to the method 600, such as sending an alert or warning message if the vessel is not where it is supposed to be based on a previous position. It is understood that the data may be collected as position reports are received, or the data may be obtained from previously collected position reports.

In some embodiments, doppelganger detection may be used to disambiguate between two or more vessels broadcasting the same MMSI—either mistakenly or maliciously. The term “doppelganger” may be used refer to vessels that transmit the same MMSI code. A plurality of such ships is often referred to as “doppelgangers.” A doppelganger (i.e., same vessel identity) check against a list of known doppelgangers may be performed. A tag may be added to messages to enable distinction between targets with the same MMSI later in the process. This method is referred to as doppelganger disambiguation. If no existing vessel can be associated with an incoming message (e.g., AIS report), then a new doppelganger code may be assigned to that AIS report for future comparisons and reference. When reports of two or more vessels having the same MMSI code are detected at different locations at the same time, they can be compared with positional probabilities, in order to produce probabilities that the report is associated with any previous vessel that also reported the same MMSI identifier. Doppelganger detection will be described further below.

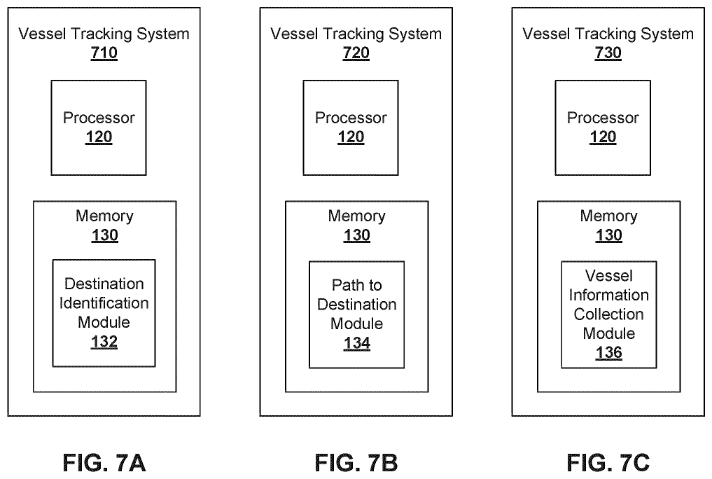

FIG. 7A illustrates, in a component diagram, another example of a vessel tracking system 710, in accordance with some embodiments. The system 710 comprises the processor 120, and memory 130 comprising the destination identification module 132.

FIG. 7B illustrates, in a component diagram, another example of a vessel tracking system 720, in accordance with some embodiments. The system 720 comprises the processor 120, and memory 130 comprising the path to destination module 134.

FIG. 7C illustrates, in a component diagram, another example of a vessel tracking system 730, in accordance with some embodiments. The system 730 comprises the processor 120, and memory 130 comprising the vessel information collection module 136.

The systems and methods described above may be used for various purposes, including, for example, determining probable current positions, determining probable entry/exit into/from an area of interest, determining a probable arrival time, etc. Vessel operators, vessel owners, government (including military, non-military, port authorities, search and rescue operations, etc.), industry oversight organizations, insurance organizations, etc., may use the systems and methods described above to track vessels worldwide or in specific areas or zones of interest.

Probable current position. As AIS position reports are infrequent, it may be desirable to have a probable current position of a vessel. For Search and Rescue operations, this is paramount for increasing the chances that a vessel in distress can be located in a timely manner. For cargo vessel operators of the same type, knowing a probable current position of their competitor allows them to make strategic decisions regarding responding to fixtures requests. I.e., if their competitor is closer to the port that requires a vessel, then there would be little point in responding to the fixture requests that are typically first-to-arrive, first to be awarded the contract.

Probable entry/exit into/from an Area of Interest. As AIS transmitted data regarding destination is notoriously unreliable, it may desirable for interested parties not directly related to a vessel's operation to understand the probable behaviour of the vessel. For example, whether the vessel is possibly going to enter a politically sensitive (e.g., military, species protected zone, etc.), and/or dangerous (e.g., known to harbor pirates, known to be under certain weather conditions such as hurricanes, etc.) area. In such cases, the interested party may decide whether interdiction is required, and at what time (based on the probable position forecast). This gives the interested party time to prepare for such an event.

Probable arrival time. A port authority can use such a system to provide probable times of arrival at destination. For port management, this is useful so that arrival planning can be done effectively in order to reduce port congestion, saving fuel for arriving ships and improving the safety of vessels around the port (e.g., the port authority can contact vessels and advise some of them to slow down in order to arrive at different times, thus reducing wait times when they arrive and improving overall safety of vessels in the port). In some embodiments, commodities on vessels may be traded while in transit. The probable arrival time could be a factor in a commodities value/price during a trade.

### Tracking/Forecasting/Doppelgangers

Modern marine vessels including passenger ships and ships with gross tonnage exceeding 300 GT that navigate open international waters are required to carry and operate an automatic transponder system known as the Automatic Identification System (AIS). AIS provides information such as the identification of the vessel, its speed, heading, and position at a given point in time as well as static information about the vessel and dynamic information about the current voyage.

Ships with AIS may exchange AIS data with other nearby ships to supplement marine radar as a means for collision avoidance. Ships with AIS may also be tracked by satellite-based AIS (S-AIS), and by AIS base stations located near shorelines (Coastal AIS or Terrestrial AIS) in order to allow various maritime and coastguard authorities to track marine vessel movements.

While S-AIS can detect vessel AIS data over a vast geographic area, the data is inherently delayed in its delivery to ground-based users due to several factors such as the location of earth stations to downlink the data, the specifics of satellite orbits and the time required to process and transport the data for users.

Most S-AIS tracking systems today will update the position, speed and direction of detected vessels at intervals of perhaps every 90 to 120 minutes on average, although particular vessels may be tracked more frequently by AIS base stations if the vessels are close enough to shore.

Furthermore, current S-AIS systems are generally only able to detect a certain percentage of vessels at each tracking interval. This is due to a number of reasons, notably the great distance between the vessel and the receiving satellite and the presence of signal interference created from observing thousands of vessels simultaneously from space.

S-AIS is the most commonly used global system for tracking vessels but other systems can also contribute similar position and vessel track data. All such systems produce data with varying degrees of delay and incompleteness similar to S-AIS. These systems are collectively position reporting systems. Different user groups may use one or more of these systems in an attempt to obtain the most complete maritime domain awareness.

For the foregoing reasons and others, at any given time, a significant percentage of vessels may be missing entirely, and an even larger proportion of position data may be out of date. Significant gaps between S-AIS measurements can result in loss of awareness of ship location, with no ability to track where they are or where they have headed.

In an aspect, the present system is adapted to execute a forecasting algorithm to forecast the position of a marine vessel based on one or more position reports (such as from satellite AIS (S-AIS) signals received from the vessel or from some passive sensor (such as radar).

The forecasting algorithm utilizes location and direction information for the vessel, and estimates one or more possible headings based on previous paths taken by other vessels from that location, and heading in substantially the same direction. Thus, a body of water can be divided into “bins” of location and direction information, and a spatial index can be built based on the previous paths taken by other vessels after passing through that bin. Other types of information may also be taken into account, such as ship type, nearby weather, ocean currents, the time of year, and other spatial or state variables specific to that bin.

Advantageously, by building clean ship tracks and then re-indexing these tracks by position/heading bins rather than time (raw position reports) or MMSI (Maritime Mobile Service Identity—a station identification number used by AIS systems), the system can quickly build a probability cloud to represent the current and future position of any vessel from a recent S-AIS message. Such an estimate may also include a dead reckoning estimate for bins with no prior history.

In another aspect, the system is adapted to generate a dynamic probability cloud starting at the time of receipt of the reported position message, and which grows over time until the cloud gets too large to be useful. Advantageously, the probability cloud identifies one or more regions of probability in which a vessel is located. The probability cloud may be visualized using colors to indicate which areas in the cloud are most likely to include the vessel, thus adding valuable information to a predicted position display.

In some embodiments the present system and method may be adapted to execute a forecasting algorithm to forecast the position of a marine vessel based on one or more satellite AIS (S-AIS) signals received from the vessel.

In an embodiment, the forecasting algorithm utilizes location and direction information for the vessel derived from Coastal and Satellite AIS, LRIT (Long Range Identification and Tracking—a different ship position reporting system also mandated by the International Maritime Organization) or other sources, and estimates one or more possible headings based on previous paths taken by vessels from that location, and heading in that direction.

In an embodiment, a body of water is divided into “bins” of location and direction information, and a spatial index is built based on the paths taken by previous vessels in each of the bins. The location and direction information for the vessel is added to the bin and updated. Other types of information may also be taken into account that represent potential influences on the likely future path of the vessel, including ship type, weather, ocean currents, the time of year, and other variables specific to that bin or vessel.

By building clean ship tracks and then re-indexing these tracks by position/heading bins rather than time (raw position data) or Ship Identifier (typically MMSI, a ship identification number used by AIS systems), the system can quickly build a probability cloud to represent the current and future position of any vessel from a recent S-AIS message. Such an estimate may also include a dead reckoning estimate for bins with no prior history.

In some embodiments, the system is also adapted to generate a dynamic probability cloud starting at the time of the most recently received position message, and which grows for a given period of time afterwards. Advantageously, the probability cloud identifies one or more regions of probability in which a vessel is located. The probability cloud may also utilize colors to indicate which areas in the cloud are most likely to include the vessel.

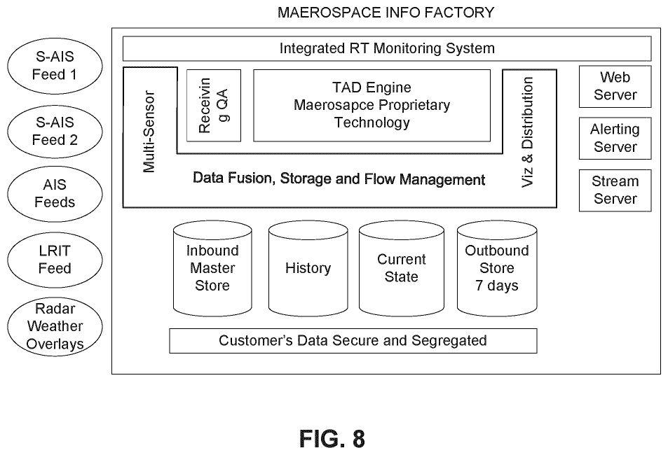

An illustrative embodiment of the system and method will now be described with reference to FIGS. 8 to 12.

FIG. 8 shows a schematic block diagram of a system architecture in accordance with an illustrative embodiment.

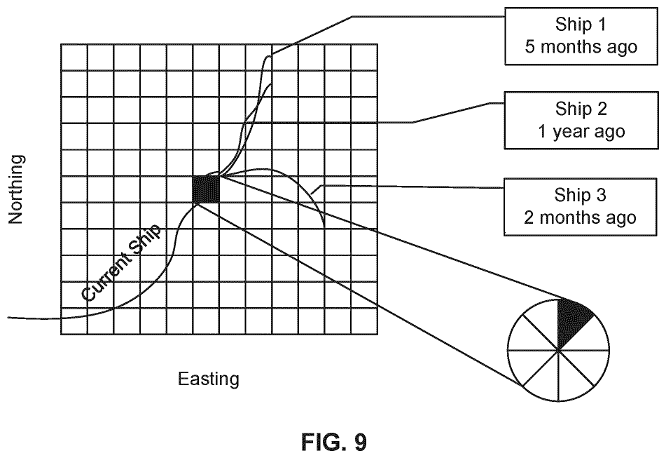

FIG. 9 shows a schematic diagram of marine vessel positions shown on a map based on satellite automatic identification system (S-AIS) data received for a vessel. As shown, a body of water is divided into substantially rectilinear areas represented in this example as squares in a grid. Of course, taking into account the curvature of the earth, these substantially rectilinear areas may be defined by lines of latitude and longitude, such that their shape and size of these substantially rectilinear areas may vary depending on their distance from the equator, and the resolution chosen. However, for the purposes of the present illustration, it is assumed that each bin is approximately square.

In this illustrative embodiment, each square represents a “bin” in which location and direction information for vessels passing through that square is indexed. Each bin contains such information for each of a number of different directions, such that the location and direction information is spatially indexed for every direction.

In an embodiment, the system and method is adapted to utilize the spatially indexed location and direction information to ask “What did previous ships, at this same location/direction, do next?” Answering this question based on a probability model results a probability cloud which can indicate one or more likely locations of a vessel over time. Advantageously, calculating the prior behaviour of vessels and indexing as described enable material improvements in the speed with which forecasts for one or more ships may be obtained, and makes the near real-time tracking of hundreds of thousands of ships possible.

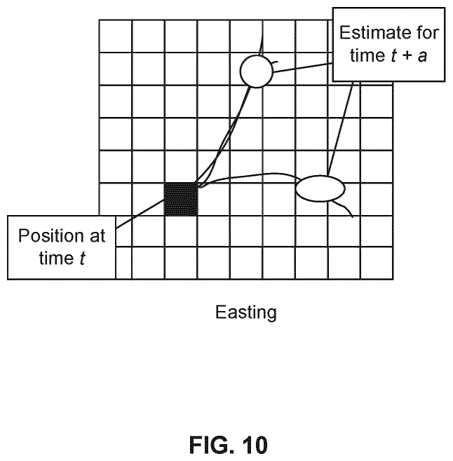

FIG. 10 shows a schematic diagram illustrating forecasting a current location of a vessel based on previously received position, identity course and speed data (such as from AIS) for a vessel. By building clean ship tracks and then re-indexing these tracks by position/heading bins rather than time (e.g. raw AIS) or MMSI (a ship track) one can quickly build a probability cloud to represent the current and future position of a ship from a recent S-AIS message. Such an estimate may include a dead reckoning estimate for regions with no history.

In an embodiment, the system is adapted to track, forecast, and detect anomalies in a vessel's reported and predicted positions. For this purpose, the system may utilize a data fusion algorithm in which the system receives AIS, Satellite-AIS and/or other position reporting feeds from any source. This data may contain comment elements (e.g. AIS message fields for identity, position, etc.) as well as some data that is unique to the supplier of the data stream (e.g. Timestamps, metatags, etc.).

In an embodiment, this data is fused by the following algorithm:
1) Store exact copy of received data in sequence
2) Quality Check comprising:
a. Data format consistent with requirements.
b. Doppelganger (two ships transmitting the same vessel identity) check against list of known Doppelgangers. Tag is added to messages to enable distinction between targets with the same MMSI later in the process.
3) Converting from time domain (one data record for each message stored in sequence) to MMSI domain with the messages stored as a track history indexed and stored in time sequence for each MMSI.

In some embodiments, the system is also adapted to utilize one or more forecasting algorithms, including the following:

1) Initial Prediction Algorithm (IPA). This algorithm receives a message, determines its validity based on a set of configuration parameters. The algorithm can filter the message, pass it on to the distribution engine without further processing and/or store it as an input for the prediction algorithm. The IPA uses the most recent two ship position reports and forecast a new position based on the elapsed time since the last report and the prior positions and speed data. The result of this prediction is compared against a bathymetry database and, if the position would place the ship in an invalid position, then creates a new predicted position in a valid location on the water.

2) Secondary Prediction Algorithms (SPA) also receive and validate the received data. A separate process periodically analyzes all available ship track histories to create a database of the typical behavior of ships in a given state (e.g. position and direction) for each small geospatial region of the world. This behaviour is represented by a list of the most likely 2-D spatial offset locations, indexed by ‘distance travelled’. Point calculations will be stored for a given distance limit (say, 500 nautical miles) into both the future and the past for any ships last observed in each specific region. Different ‘point databases’ can be maintained for ships of a given class, stated destination, size, etc., and separate databases or tables may also be used for different seasons. An online, near-real-time process updates the position of every ship in the global database by using its most recent reported position, heading, ship class, speed, and other state variables as an index to query one or more of the point databases described above. Using this system, a set of predicted current and future positions for every ship is then computed from the past local behavior. The current and future state of the ship is stored in a separate state database.

3) Region of Probability generator software will, on demand or periodically, generate a geospatial region of probability of target's location for a specified point in time (present, past, or future). This region will be configurable to represent different levels of confidence in the location (e.g. 90% probability that the target is within the region). The region will be computed, stored and available for delivery as data elements to any compatible display system.

4) Multiple ships can report the same station identifier (typically, but not always, the MMSI number), although this is not the intended use of AIS. Such duplicated identifiers are referred to as Doppelgangers. When these reports are detected, they can be compared with the positional probabilities described earlier, in order to produce probabilities that the report is associated with any previous vessel that also reported the same MMSI identifier. If no existing vessel can be associated with the incoming message, then a new Doppelganger code is assigned to the current message for future comparisons and reference. This method is referred to as Doppelganger disambiguation.

5) Additional data inputs (e.g. weather or wave data) may be incorporated into the prediction algorithm to obtain more accurate forecasts.

Anomaly Definitions

In another aspect, the system and method is adapted to evolve a list of anomalies associated with AIS messages and ship behaviour as shown in Schedule 1, below. These anomalies fit one of two classes: intrinsic and behavioural (a.k.a. contextual).

| Item | Anomaly | Description |
|---|---|---|
| 1 | DOPPELGANGER | One or more other ships have been detected |
| | | using this ship identifier (e.g. MMSI) |
| 2 | Invalid MMSI | Received MMSI number does not conform to AIS |
| | | standards. |
| 3 | SHIP IS DRIFTING | Ship heading is excessively different from its |
| | | course over ground. |
| 4 | BAD COG | The reported Course Over Ground value is |
| | | outside of range 0-359 |
| 5 | BAD HEADING | The reported Heading value is outside of range |
| | | 0-359 |
| 6 | BAD ACCELERATION | The reported Acceleration is unrealistic (outside |
| | | of a pre-defined range) |
| 7 | BAD SOG | The reported Speed Over Ground is unrealistic |
| | | (outside of a pre-defined range) |
| 8 | BAD SHIP TYPE | The reported ship Type (e.g. Cargo, Tanker, etc.) |
| | | is invalid by ITU standards |
| 9 | BAD DIMENSION | Reported Ship dimensions do not match pre- |
| | | defined values for that ship. |
| 10 | NAME CHANGE | Reported Ship Name has changed from |
| | | previously reported names. |
| 11 | NEW SHIP | The reported MMSI has not been previously |
| | | detected in the area of interest. |
| 12 | NEW IMO | The reported IMO (International Maritime |
| | | Organization number - an unique identifier |
| | | assigned to vessels) has not been previously |
| | | detected in the Area of Interest |
| 13 | MISSING SHIP | The ship has not been detected for a period of |
| | | time that exceeds a predetermined value for that |
| | | ship. |
| 14 | MMSI FOUND | A ship previously reported as MISSING has been |
| | | detected. |
| 15 | INVALID MESSAGE TYPE | The reported message type is outside of the |
| | | range as defined in the AIS standard |
| 16 | EXCESSIVE MESSAGE LENGTH | Message length is outside of the allowed length |
| | | as defined in the AIS standard |
| 17 | INVALID MMSI FORMAT | MMSI format (i.e. nine numeric characters) is |
| | | invalid as defined in the AIS standard |
| 18 | INVALID IMO FORMAT | IMO number format is invalid as defined in the |
| | | AIS standard |
| 19 | INVALID CALL SIGN | Call Sign format is invalid as defined in the AIS |
| | | standard |
| 20 | UNASSIGNED IMO | The IMO number does not exist in a predefined |
| | | list of IMO numbers in use. |
| 21 | UNLISTED MMSI | MMSI does not exist in a predefined list of MMSI |
| | | numbers. |
| 22 | IMO-MMSI MISMATCH | The IMO number was associated previously with |
| | | a different MMSI. |
| 23 | SHIP STALLED OR GROUNDED | Speed over Ground is zero away from normal |
| | | anchorage or port region. |
| 24 | EXCCESSIVE SOG | Speed Over Ground exceeds maximum limit for |
| | | that ship or ship class |
| 25 | SHIP ON LAND | Reported ship position is not on water. |
| 26 | INVALID LAT/LON | Is not on planet. Latitude or Longitude is outside |
| | | of range 0-360. |
| | | Special Case: Lat/Lon of 91/181 indicates |
| | | disabled GPS input to AIS transceiver. |
| 27 | RENDEZVOUS/COLLISION | Predicted or current position shows two or more |
| | | ships exceeding predefined proximity limits. |
| 28 | EXCESSIVE MOVEMENT | Change from previous position message is |
| | | outside predefined limits. |
| 29 | CUTTING CORNER | Predicted position outside of route usually |
| | | followed by vessels and distance to shore is |
| | | closer than pre-defined limits |
| 30 | CHANGE OF COURSE | Reported position outside of expected path |
| | | beyond limits defined for that vessel. |
| 31 | UNNECESSARY DETOUR | Vessel takes route longer by x nautical miles than |
| | | an usual route |
| 32 | INVALID CHANGE OF DIRECTION | Course Over Ground change from previous |
| | | position report exceeds predefined limits. |
| 33 | OUT OF DATE DESTINATION | Reported Destination did not change after |
| | | departing reported destination. |
| 34 | | Additional anomalies may be added from time to |
| | | time. |

Anomaly tagging specifications—In an embodiment, the system may include a standard for tagging AIS messages with these anomalies. Forecasted messages may be tagged with these anomalies. The tags can then be used by display and alerting software as well as analytic software downstream of the forecasting algorithms.

Anomaly detection and alerting methods—In an embodiment, the system is adapted to detect anomalies (e.g. a position report inside a user-defined geo-fence) in both forecasted AIS messages and AIS messages.

Message Generation specifications and software—The AIS message specification (NMEA standard) and other standard tracking protocols allow for proprietary data to be embedded in AIS messages.

In an embodiment, the system and method retrieves the desired state information (e.g. forecasted position) of ships from its database periodically and constructs NMEA and AIS-standards compliant messages comprising an appropriately typed AIS message with anomaly metadata embedded according to the system standard. These messages are then passed to another system for display, streaming and alerting. Such display systems will accept and display the standard NMEA and AIS message components and will ignore proprietary metadata unless programmed to recognize the anomaly tags defined by the present invention, thus ensuring compatibility with existing display systems.

### Forecasting Implementation

In some embodiments, each of the forecasting algorithms above may be implemented to perform the following functions:

### Receiving

1) Receive and store all data for a customer-specific period of time (e.g. 12 months).

2) Doppelganger detection and recoding as required for forecasting

3) Tagging of received messages with intrinsic anomalies (this function may be performed at later stages in some implementations)

4) Indexing and reorganizing of data as required for Forecasting algorithms

Forecasting

5) Update and maintain a current state database (including, but not limited to, ID, position, heading speed and course) for a minimum capacity of 200,000 distinct MMSIs not less than once every ten minutes.

6) Update and maintain a similar state database for each of the next number of desired time periods (typically 4 hours) not less than once every 10 minutes.

7) Ability to limit outputs to a pre-defined list of ships.

8) Ability to distinguish between doppelgangers and to track them separately.

9) Ability to incorporate contextual information from other data sources (e.g. weather, navigation channels, etc.) into the database and the dynamic assessment of the present and future ship positions.

10) Ability to maintain a history of forecasting accuracy for each ship by comparing new positions received with the prior forecasts, calculating meaningful statistics and storing this information for each ship. The per-ship tracking of these statistics is essential due to wide range of possible values which renders globally computed statistics useless.

11) Ability to maintain a history of the timing of received data from the ship in order to detect unexpected failure of transmission or reception of signals. The time since last message is computed upon receipt. This time difference is then used to calculate the meaningful performance statistics of data reception and storing this information for each ship. The per-ship tracking of these statistics is essential due to wide range of possible values which renders globally computed statistics useless.

Anomaly Detection and Alerting

12) Detect and tag some or all of the anomalies as shown in Schedule 1 (additional anomalies may be added as they are discovered and tested).

13) Provide an interface to enable the system to generate user alerts on all detected anomalies.

14) Pass data (in a real-time stream, batch delivery on upon request by the downstream software) to a software tool for proper visualization of tracks on a map up to current or future forecasted position.

Visualization

15) Deliver data and related metadata to a software tool to visualize regions of probabilities within the software.

Monitoring and Logging

16) Implement visualization tool for monitoring real-time status of the flow of data from receipt of raw data to delivery of data to outside systems.

17) Implement monitoring tool running outside of the primary data center to detect data flow and volume to each customer and to generate email and visual alert if output falls below a defined volume for more than a defined period of time (typically 25 minutes).

Verification

18) Per ship and group technical comparison showing performance of each algorithm versus dead reckoning, time between detections and anomalies detected.

Visualization

Existing software solutions may provide for certain platform capabilities to aid in the visualization of vessel location, data management, alerting, tracking and other features inherent to the forecasting service.

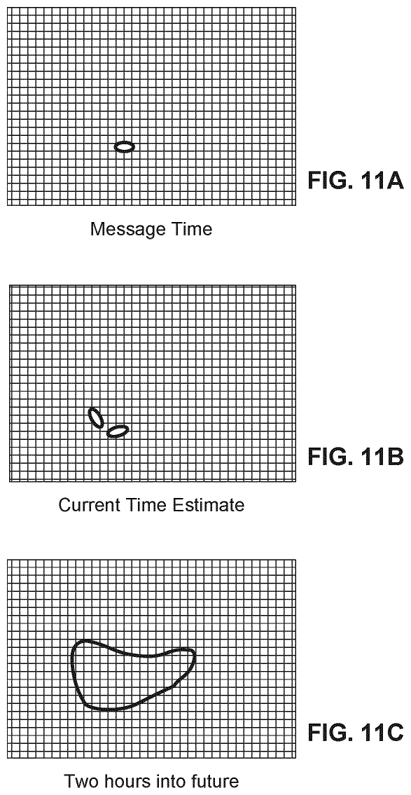

FIGS. 11A to 11C show illustrative examples of a probability cloud indicating one or more areas identified as being likely to include the vessel at three different points in time. Having a probability cloud for both the current and future position of a ship can express relative levels of ‘quality’ for a position report which can be used to prioritize search areas during vessel interdiction or search efforts. Furthermore, increasing uncertainty with time corresponds to a widening cloud of probability, until eventually the cloud becomes uninformative, depending on the users needs.

In an embodiment, spatial indexing provides various advantages, including the ability to observe trends in a region over seasons and years.
Fishing and natural resource evolution
Changes in container traffic
Fast answer to “Who has been here, and when?”
Ability to detect co-incident anomalous behavior of multiple vessels
Ability to maintain multiple predictions for hundreds of thousands of vessels with very short update intervals.
Ability to optimize use of surface and air assets in searching or interdicting a target vessel
Ability to more quickly and accurately detect anomalies in reported positions in order to detect threats, suspicious behavior, ships in distress or unreported changes in direction.
Ability to detect when a ship may have ceased transmissions by noting statistically meaningful time since last received.
Ability to detect unexpected positions more quickly than with other methods because the expected state of each ship is stored by the algorithm and is immediately available without further computation.

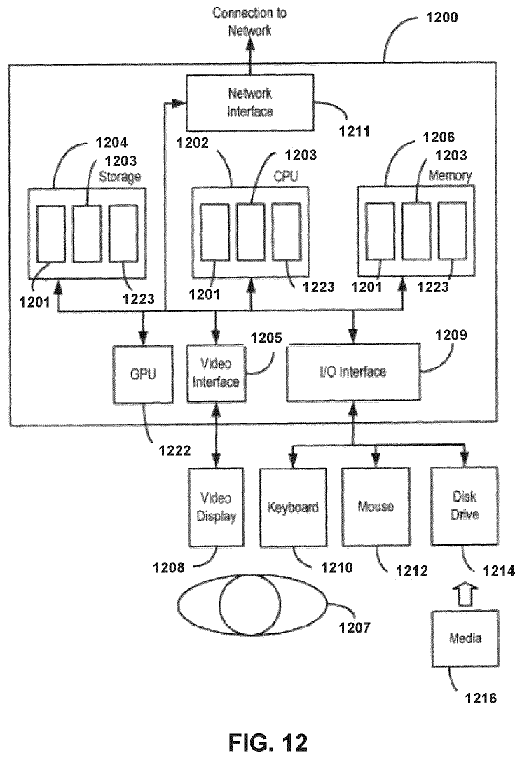

FIG. 12 shows a schematic block diagram of a generic computing device which may provide an operating embodiment in one or more embodiments. A suitably configured computer device, and associated communications networks, devices, software and firmware may provide a platform for enabling one or more embodiments as described above. By way of example, b shows a generic computer device 1200 that may include a central processing unit (“CPU”) 1202 connected to a storage unit 1204 and to a random access memory 1206. The CPU 1202 may process an operating system 1201, application program 1203, and data 1223. The operating system 1201, application program 1203, and data 1223 may be stored in storage unit 1204 and loaded into memory 1206, as may be required. Computer device 1200 may further include a graphics processing unit (GPU) 1222 which is operatively connected to CPU 1202 and to memory. An operator 1207 may interact with the computer device 1200 using a video display 1208 connected by a video interface 1205, and various input/output devices such as a keyboard 1210, pointer 1212, and storage 1214 connected by an I/O interface 1209. In known manner, the pointer 1212 may be configured to control movement of a cursor or pointer icon in the video display 1208, and to operate various graphical user interface (GUI) controls appearing in the video display 1208. The computer device 1200 may form part of a network via a network interface 1211, allowing the computer device 1200 to communicate with other suitably configured data processing.

Thus, in an aspect, there is provided a computer-implemented system for forecasting the position of a marine vessel based on one or more position reports, the system adapted to: provide, for a body of water, a spatial index comprising a plurality of bins, each bin containing location and direction information specific to each bin; obtain one or more position reports for a vessel comprising position and direction information; determine one or more bins the vessel has travelled through, and execute a forecasting algorithm based on the spatial index and the location and direction information specific to the one or more bins through which the vessel has travelled.

In an embodiment, the system is further adapted to: obtain contextual data about a surrounding ocean state; obtain current dynamic contextual information relating to the state of the vessel and the surrounding ocean state corresponding to the information related to each bin; and execute a forecasting algorithm based on the spatial index, the location and direction information specific to the one or more bins through which the vessel has travelled, and the comparison of contextual information stored in one or more bins with that of the current dynamic situation of the vessel and the surrounding ocean state.

In another embodiment, the system is further adapted to detect an unexpected position of a marine vessel based on a comparison of each new position report combined with a stored history of the statistical accuracy of the forecasting algorithms for that specific vessel by computing and updating the statistical accuracy of recent forecasts upon receipt of each new position report.

In another embodiment, the statistical accuracy includes a measure of a median absolute deviation.

In another embodiment, the system is further adapted to store a per-vessel statistical forecasting accuracy for each vessel.

In another embodiment, the system is further adapted to compare each new position report with the statistical forecasting accuracy for that vessel and determines if the new position is sufficiently different from the expected position that it exceeds a predefined threshold constituting an anomalous position.

In another embodiment, the system is further adapted to: detect an unexpected failure to receive a position report from a marine vessel based on a comparison of the time since the previous position report with a stored history of the statistical periodicity of message receipt for that specific vessel.

In another embodiment, the system is further adapted to update the statistical accuracy of the time between receipt of position reports upon receipt of each new position report.

In another embodiment, the system is further adapted to: compare the time since the prior position report with the statistical time periodicity of message receipt for that vessel; and determine if the new time difference is sufficiently different from the expected time that it exceeds a predefined threshold constituting an anomalous position.

In another embodiment, the system is further adapted to: monitor the time since receipt of the message for one or more ships; and compare the elapsed time to the stored statistical periodicity of message receipt for that vessel and determines if the elapsed time is sufficiently different from the expected time that it exceeds a predefined threshold constituting an anomalous position.

In another aspect, there is provided a computer-implemented method for forecasting the position of a marine vessel based on one or more position reports, comprising: providing for a body of water a spatial index comprising a plurality of bins, each bin containing location and direction information specific to each bin; obtaining one or more position reports for a vessel comprising position and a direction information; determining one or more bins the vessel has travelled through, and executing a forecasting algorithm based on the spatial index and the location and direction information specific to the one or more bins through which the vessel has travelled.

In an embodiment, the method further comprises: obtaining contextual data about a surrounding ocean state; obtaining current dynamic contextual information relating to the state of the vessel and the surrounding ocean state corresponding to the information related to each bin; and executing a forecasting algorithm based on the spatial index, the location and direction information specific to the one or more bins through which the vessel has travelled, and the comparison of contextual information stored in one or more bins with that of the current dynamic situation of the vessel and the surrounding ocean state.

In another embodiment, the method further comprises: detecting an unexpected position of a marine vessel based on a comparison of each new position report combined with a stored history of the statistical accuracy of the forecasting algorithms for that specific vessel by computing and updating the statistical accuracy of recent forecasts upon receipt of each new position report.

In another embodiment, the statistical accuracy includes a measure of a median absolute deviation.

In another embodiment, the method further comprises: storing a per-vessel statistical forecasting accuracy for each vessel.

In another embodiment, the method further comprises: comparing each new position report with the statistical forecasting accuracy for that vessel; and determining if the new position is sufficiently different from the expected position that it exceeds a predefined threshold constituting an anomalous position.

In another embodiment, the method further comprises: detecting an unexpected failure to receive a position report from a marine vessel based on a comparison of the time since the previous position report with a stored history of the statistical periodicity of message receipt for that specific vessel.

In another embodiment, the method further comprises: updating the statistical accuracy of the time between receipt of position reports upon receipt of each new position report.

In another embodiment, the method further comprises: comparing the time since the prior position report with the statistical time periodicity of message receipt for that vessel; and determining if the new time difference is sufficiently different from the expected time that it exceeds a predefined threshold constituting an anomalous position.

In another embodiment, the method further comprises: monitoring the time since receipt of the message for one or more ships; and comparing the elapsed time to the stored statistical periodicity of message receipt for that vessel and determines if the elapsed time is sufficiently different from the expected time that it exceeds a predefined threshold constituting an anomalous position.

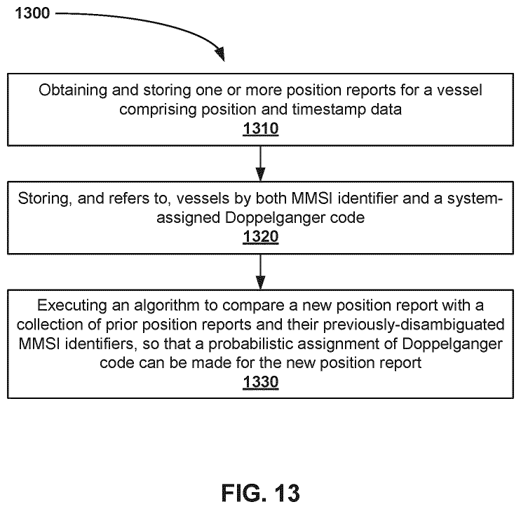

In another aspect, as shown in FIG. 13, there is provided a computer-implemented 1300 method for disambiguating AIS transmissions from different vessels using the same MMSI identifier, comprising: obtaining and storing 1310 one or more position reports for a vessel comprising position and timestamp data; storing 1320, and refers to, vessels by both MMSI identifier and a system-assigned Doppelganger code, and; executing 1330 an algorithm to compare a new position report with a collection of prior position reports and their previously-disambiguated MMSI identifiers, so that a probabilistic assignment of Doppelganger code can be made for the new position report.

The discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

1. A vessel tracking system comprising:
a processor; and
a memory comprising a sequence of instructions which when executed by the processor configure the processor to:
obtain characteristics data of a vessel;
obtain destination identifiers for historical destinations of vessels having similar characteristics data;
determine a percentage of likelihood for each destination identifier; and
report the destination identifiers and corresponding percentages of likelihood.

2. The system as claimed in claim 1, wherein the characteristics data of the vessel comprises:
a maritime mobile service identifier (MMSI) of the vessel; and
a current location of the vessel.

3. The system as claimed in claim 2, wherein the characteristics data of the vessel further comprises at least one of:
a current heading of the vessel;
a current speed of the vessel;
a vessel type of the vessel; or
a draught of the vessel.

4. The system as claimed in claim 1, wherein the processor is further configured to obtain characteristics data of weather conditions.

5. The system as claimed in claim 4, wherein the characteristics data of the weather conditions comprises at least one of:
surface winds;
currents; or
sea state.

6. The system as claimed in claim 1, wherein the percentage likelihood of a particular destination identifier comprises a ratio between a number of vessels having similar characteristics data that had the historical destination associated with the particular destination identifier, and a total of all vessels having similar characteristics data.

7. The system as claimed in claim 1, wherein the processor is configured to:
select a predicted destination for the vessel from the destination identifiers;
for each vessel having similar characteristics, determine the path taken by that vessel having similar characteristics data for the predicted destination; and
bundle paths taken by each vessel having similar characteristics data for the predicted destination.

8. The system as claimed in claim 7, wherein the processor is configured to:
obtain historical position reports for each vessel having similar characteristics data for the predicted destination, the historical position reports comprising historical position information for that vessel between the current location and the predicted destination; and
merge similar path segments between historical position reports for different vessels having similar characteristics data.

9. The system as claimed in claim 7, wherein the predicted destination comprises a highest percentage value destination identifier.

10. The system as claimed in claim 1, wherein the processor is configured to:
determine doppelganger vessels among the vessels having similar characteristics data; and
treat each doppelganger vessel as another vessel having similar characteristics data.

11. A method of tracking a vessel, the method comprising:
obtaining characteristics data of a vessel;
obtaining destination identifiers for historical destinations of vessels having similar characteristics data;
determining a percentage of likelihood for each destination identifier; and
reporting the destination identifiers and corresponding percentages of likelihood.

12. The method as claimed in claim 11, wherein the characteristics data of the vessel comprises:
a maritime mobile service identifier (MMSI) of the vessel; and
a current location of the vessel.

13. The method as claimed in claim 12, wherein the characteristics data of the vessel comprises at least one of:
a current heading of the vessel;
a current speed of the vessel;
a vessel type of the vessel; or
a draught of the vessel.

14. The method as claimed in claim 11, comprising obtaining characteristics data of weather conditions.

15. The method as claimed in claim 14, wherein the characteristics data of the weather conditions comprises at least one of:
surface winds;
currents; or
sea state.

16. The method as claimed in claim 11, wherein the percentage likelihood of a particular destination identifier comprises a ratio between a number of vessels having similar characteristics data that had the historical destination associated with the particular destination identifier, and a total of all vessels having similar characteristics data.

17. The method as claimed in claim 11, comprising:
selecting a predicted destination for the vessel from the destination identifiers;
for each vessel having similar characteristics data, determining the path taken by that vessel having similar characteristics for the predicted destination; and
bundling paths taken by each vessel having similar characteristics data for the predicted destination.

18. The method as claimed in claim 17, comprising:
obtaining historical position reports for each vessel having similar characteristics data for the predicted destination, the historical position reports comprising historical position information for that vessel between the current location and the predicted destination; and
merging similar path segments between historical position reports for different vessels having similar characteristics data.

19. The method as claimed in claim 17, wherein the predicted destination comprises a highest percentage value destination identifier.

20. The method as claimed in claim 11, comprising:
determining doppelganger vessels among the vessels having similar characteristics data; and
treating each doppelganger vessel as another vessel having similar characteristics data.

21. (canceled)

22. (canceled)

23. (canceled)

24. (canceled)
